(19) United States
(12) Patent Application Publication
(10) Pub. No.: US 2007/0134366 A1
(43) Pub. Date: Jun. 14, 2007

(54) Injection die with an early-returning apparatus

(76) Inventors: Ching-Chang Wang, Tu-Cheng City (TW); Chih-Yu Chen, Tu-Cheng City (TW); Jian-Ren Wang, Tu-Cheng City (TW); Ke-Meng He, Tu-Cheng City (TW)

Correspondence Address: LIN & ASSOCIATES INTELLECTUAL PROPERTY, P.O. BOX 2339, SARATOGA, CA, 95070-0339, US

(21) Appl. No.: 11/300,669

(22) Filed: Dec. 13, 2005

(51) Int. Cl. B29C 45/22

(52) U.S. Cl. 425/556

(57) ABSTRACT

An injection die with an early-returning apparatus includes a lower fixed plate; a plurality of padding blocks located in the lower fixed plate; a male die mounted on the padding blocks; a female die coupled with the male die; an upper fixed plate mounted on the female die; a draw core unit installed in the female die; a shaft seat unit located in a space between the padding blocks and mounted on the lower fixed plate; a restoration unit fixed on a shaft-fixing plate of the shaft seat unit and inserted into the male die and an early-returning apparatus mounted on the shaft seat unit and the upper fixed plate and inserted into the male die and the female die. The early-returning apparatus includes a restoration cannulation unit located on the shaft seat unit, a restoration guide bushing unit sleeved on the restoration cannulation unit and installed in the male die and a restoration pushing shaft unit fixed on the upper fixed plate and inserting into the restoration guide bushing unit and the restoration cannulation unit. The restoration cannulation unit has a plurality of baffle blocks pivotally installed in the top portion of the restoration cannulation unit. The restoration guide bushing unit has an enlarged head portion to engage with the male die and receive the baffle blocks.

### BACKGROUND OF THE INVENTION

1. Field of the Invention

The present invention relates to an injection die, and in particular to an injection die with an early-returning apparatus.

2. The Related Art

A conventional injection die 100′ is shown in FIG. 8. The injection die 100′ usually comprises a lower fixed plate 10′, a plurality of padding blocks 20′ mounted on the lower fixed plate 10′, a male die 30′ located on the two padding blocks 20′, a female die 40′ coupled with the male die 30′, an upper fixed plate 50′ mounted on the female die 40′, a padding plate 60′ located on the lower fixed plate 10′ in a space between the two padding blocks 20′, a shaft-fixing plate 70′ mounted on the padding plate 60′, a pushing shaft 75′ fixed in the shaft-fixing plate 70′, a restoration unit 80′ fixed in the shaft-fixing plate 70′ and a draw core unit 90′ installed in the female die 40′. The draw core unit 90′ comprises an inclined guide shaft 91′ located on the upper fixed plate 50′, a sliding block 92′ installed in the female die 40′ and an inclined groove 93′ formed in the male die 30′.

When the male die 30′ couples with the female die 40′, the inclined guide shaft 91′ inserts into the inclined groove 93′ and the sliding block 92′ moves toward the pushing shaft 75′. If the pushing shaft 75′ does not completely retract into the male die 30′ before the sliding block 92′ reaches at the location of the pushing shaft 75′, the pushing shaft 75′ would be crashed, as shown in FIG. 8.

### SUMMARY OF THE INVENTION

An object of the present invention is to provide an injection die with an early-returning apparatus. The injection die with an early-returning apparatus includes a lower fixed plate, a plurality of padding blocks located in the lower fixed plate, a male die mounted on the padding blocks, a female die coupled with the male die, an upper fixed plate mounted on the female die, a draw core unit installed in the female die, a shaft seat unit located in a space between the padding blocks and mounted on the lower fixed plate, a restoration unit fixed on a shaft-fixing plate of the shaft seat unit and inserted into the male die and an early-returning apparatus mounted on the shaft seat unit and inserted into the male die and the female die. The early-returning apparatus includes a restoration cannulation unit located on the shaft seat unit, a restoration guide bushing unit sleeved on the restoration cannulation unit and installed in the male die and a restoration pushing shaft unit fixed on the upper fixed plate and inserting into the restoration guide bushing unit and the restoration cannulation unit. The restoration cannulation unit has a plurality of baffle blocks pivotally installed in the top portion of the restoration cannulation unit. The restoration guide bushing unit has an enlarged head portion to engage with the male die and receive the baffle blocks. When the injection die with an early-returning apparatus clamps, the restoration pushing shaft unit pushes the restoration cannulation unit and the shaft seat unit moving downward. A pushing shaft of the shaft seat unit retracts into the male die before a sliding block of the draw core apparatus reaches at the location of the pushing shaft. Therefore, the pushing shaft would not be crashed by the sliding block.

### BRIEF DESCRIPTION OF THE DRAWINGS

The exact nature of this invention, as well as other objects and advantages thereof, will be readily apparent from consideration of the following specification relating to the accompanying drawings, in which like reference characters designate the same or similar parts throughout the figures thereof and wherein:

FIG. 1 is a perspective view of an injection die with an early-returning apparatus according to the invention;

FIG. 2 is a perspective view of a restoration pushing cannulation unit according to the invention;

FIG. 3 is a perspective view of a restoration guide bushing unit according to the invention;

FIG. 4 is a perspective view of a restoration pushing shaft unit according to the invention;

FIG. 5 is a cross-sectional view showing a male die and a female die separated;

FIG. 6 is a cross-sectional view showing that the male die moves toward and the female die and a restoration pushing shaft of the restoration pushing shaft unit inserts into the restoration guide bushing unit;

FIG. 7 is a view cross-sectional showing that a sliding block moves toward a pushing shaft and the pushing shaft retracts into the male die; and

FIG. 8 is a perspective view of a conventional injection die.

### DETAILED DESCRIPTION OF THE PREFERRED EMBODIMENT

Detailed description will hereunder be given of the preferred embodiment of an injection die with an early-returning apparatus according to the present invention with reference to the accompanying drawings.

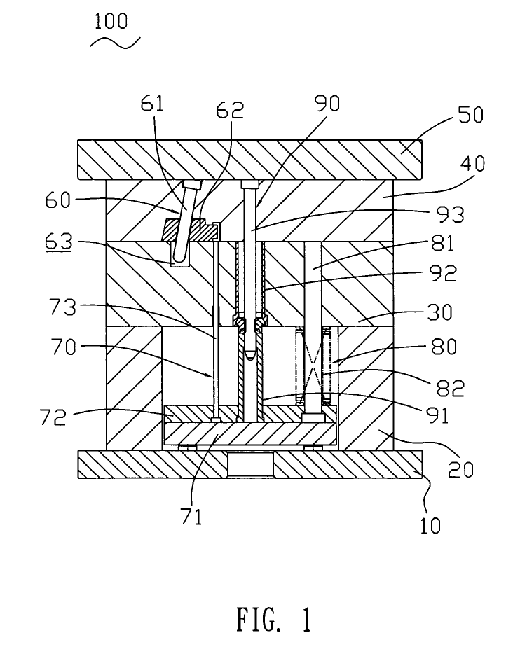

Please refer to FIG. 1. An injection die with an early-returning apparatus 100 according to the present invention comprises a lower fixed plate 10, a plurality of padding blocks 20 located on the lower fixed plate 10, a male die 30 mounted on the padding blocks 20, a female die 40 coupled with the male die 30, an upper fixed plate 50 mounted on the female die 40, a draw core unit 60 installed in the female die 40, a shaft seat unit 70 located in a space between the padding blocks 20 and mounted on the lower fixed plate 10, a restoration unit 80 fixed on the shaft seat unit 70 and inserted into the male die 30 and an early-returning apparatus 90 mounted on the shaft seat unit 70 and inserted into the male die 30 and the female die 40.

The draw core unit 60 comprises an inclined guide shaft 61 located on the upper fixed plate 50, a sliding block 62 installed in the female die 40 and an inclined groove 63 formed in the male die 30.

The shaft seat unit 70 includes a padding plate 71 located on the lower fixed plate 10, a shaft-fixing plate 72 mounted on the padding plate 71 and a pushing shaft 73 fixed in the shaft-fixing plate 72 and inserted through the male die 30.

The restoration unit 80 comprises a restoration shaft 81 fixed in the shaft-fixing plate 72 and at least one spring 82 sleeved on the restoration shaft 81.

Please refer to FIGS. 1 to 4. The early-returning apparatus 90 includes a restoration cannulation unit 91 which is located on the padding plate 71, a restoration guide bushing unit 92 which is installed in the male die 30 and a restoration pushing shaft unit 93 which is fixed on the upper fixed plate 50.

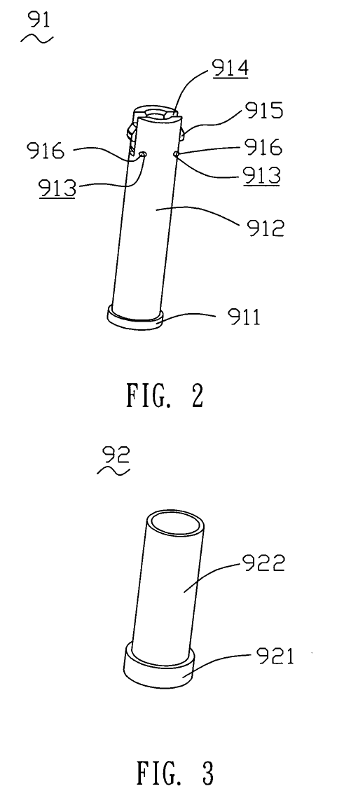

Referring to FIG. 2, the restoration cannulation unit 91 includes a head portion 911 fixed into the shaft-fixing plate 72 of the shaft seat unit 70, a restoration cannulation 912 extended from the head portion 911, a plurality of axis holes 913 formed in the upper portion of the restoration cannulation 912, a plurality of grooves 914 formed in the restoration cannulation unit 91 and a plurality of baffle blocks 915 installed in the holding grooves 914 respectively. A plurality of pivots 916 insert into the axis holes 913 and pivotally engage with the baffle blocks 915, respectively. Therefore, the baffle block 915 pivotally rotates around the pivot 916.

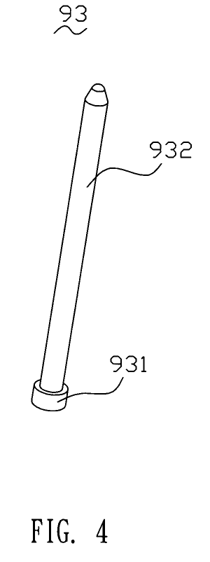

As show in FIG. 3 and FIG. 4, the restoration guide bushing unit 92 is sleeved on the restoration cannulation unit 91. The restoration guide bushing unit 92 comprises an enlarged head portion 921 engaged with the male die 30 and a guide bushing 922 extending from the enlarged head portion 921 and installed in the male die 30. The restoration pushing shaft unit 93 includes a seat 931 engaged with the upper plate 50 and a restoration pushing shaft 932 extending from the seat 931. The restoration pushing shaft unit 93 inserts into the restoration guide bushing unit 92 and the restoration cannulation unit 91.

In the following paragraphs, the movement of the early-returning apparatus 90 will be described in detail.

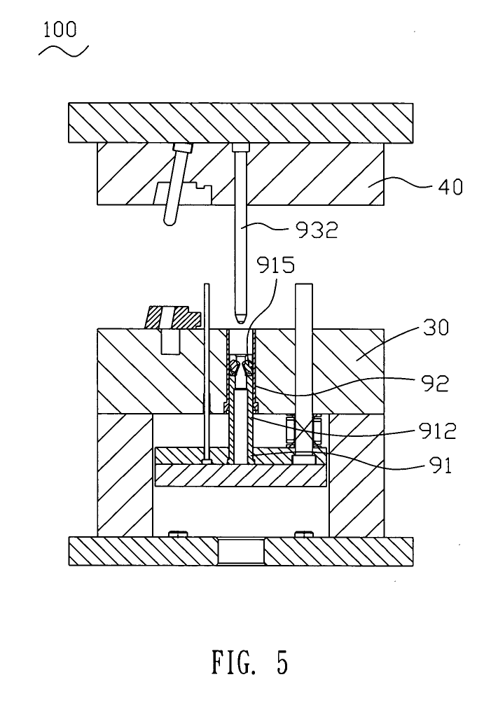

Referring to FIG. 5, the male die 30 separates from the female die 40 when the injection die with an early-returning apparatus 100 is opened. While the injection die with an early-returning apparatus 100 begins to clamp, the male die 30 moves toward the female die 40. The restoration cannulation unit 91 and the restoration guide bushing unit 92 move toward the female die 40. The restoration pushing shaft 932 inserts into the restoration guide bushing unit 92. At this time, the upper portion of the restoration cannulation 912 inserts into the restoration guide bushing unit 92 and the two baffle blocks 915 are pressed inwardly in order to allow the restoration cannulation 912 sliding in the restoration guide bushing unit 92.

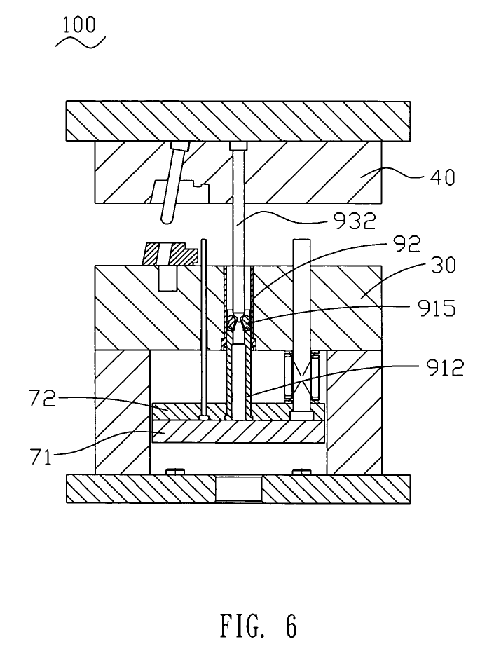

Referring to FIG. 6, the male die 30 moves toward the female die 40 and the restoration pushing shaft 932 inserts into the restoration guide bushing unit 92. The front portion of the restoration pushing shaft 932 touches the two baffle blocks 915. The restoration pushing shaft 932 can't pass through a clearance formed between the baffle blocks 915 because the clearance is smaller than the diameter of the restoration pushing shaft 932. While the male die 30 continuously moves toward the female die 40, the restoration pushing shaft 932 pushes the baffle blocks 915 and the restoration cannulation 912 to move down. At this moment, the padding plate 71 and the shaft-fixing plate 72 move down together with the restoration cannulation 912.

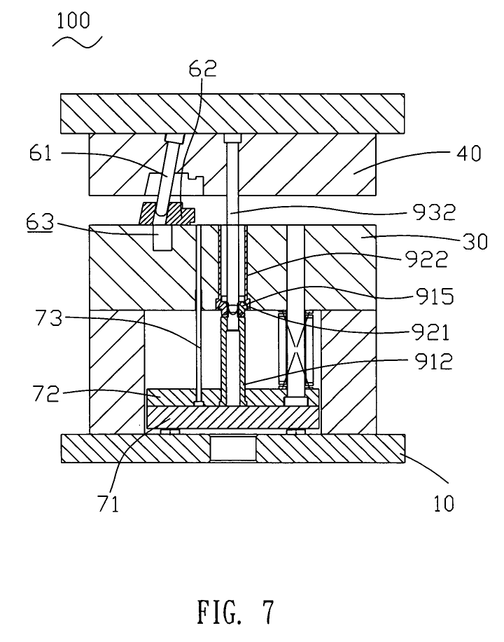

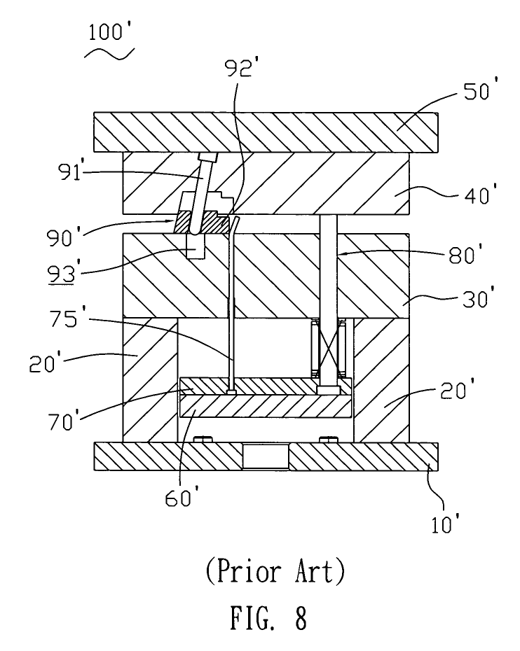

While the restoration pushing shaft 932 pushes the two baffle blocks 915 to move into the bottom of the guide bushing 922. The restoration cannulation 912, the padding plate 71 and the shaft-fixing plate 72 move to the lower fixed plate 10, as shown in FIG. 7. In other words, the padding plate 71 and the shaft-fixing plate 72 are in a restoration state. The top end of the pushing shaft 73 is located below the top face of the male die 30. Then, the restoration pushing shaft 932 continuously pushes the baffle blocks 915 to move down. When the baffle blocks 915 are received in the guide bushing 922, the baffle blocks 915 are pressed to rotate inward. When the baffle block 915 slides into the enlarged head portion 921, the baffle blocks 915 are released and rotate outward. Therefore, the clearance formed between the baffle blocks 915 is enlarged in order to allow the restoration pushing shaft 932 passing through the clearance. The restoration pushing shaft 932 passes through the clearance formed between the baffle blocks 915 and slides into the restoration cannulation 912. The female die 40 contacts with the male die 30. The inclined guide shaft 61 inserts into the inclined groove 63, so that the sliding block 62 is guided to move toward the right side. When the sliding block 62 move toward the right side, the pushing shaft 73 retracts into the male die 30 so that the sliding blocks 62 would not crash the pushing shaft 73, as can be seen in FIG. 1.

According to the injection die with an early-returning apparatus 100 of the present invention, the pushing shaft 73 is restored firstly. In such case, the inclined guide shaft 61 and the sliding block 62 would not crash the pushing shaft 73.

It should be understood, however, that there is no intention to limit the invention to the specific forms disclosed, but on the contrary, the invention covers all modifications, alternate constructions and equivalents falling within the spirit and scope of the invention as expressed in the appended claims.

What is claimed is:

1. An injection die with an early-returning apparatus comprising:
a lower fixed plate;
a plurality of padding blocks located on the lower fixed plate;
a male die mounted on the padding blocks;
a female die coupled with the male die;
an upper fixed plate mounted on the female die;
a draw core unit installed in the female die;
a shaft seat unit located in a space formed between the padding blocks,
the shaft seat unit mounted on the lower fixed plate and passing through the male die;
a restoration unit fixed on the shaft seat unit and inserted into the male die; and
an early-returning apparatus mounted on the shaft seat unit and the upper fixed plate and inserted into the male die and the female die in order to push the shaft seat unit to the lower fixed plate.

2. The injection die with an early-returning apparatus as claimed in claim 1, wherein the early-returning apparatus includes a restoration cannulation unit located on the shaft seat unit, a restoration guide bushing unit sleeved on the restoration cannulation unit and installed in the male die and a restoration pushing shaft unit fixed on the upper fixed plate and inserted into the restoration guide bushing unit and the restoration cannulation unit; the restoration cannulation unit has a plurality of baffle blocks pivotally installed in the top portion of the restoration cannulation unit; and the restoration guide bushing unit has an enlarged head portion to engage with the male die and receive the baffle blocks.

3. The injection die with an early-returning apparatus as claimed in claim 2, wherein the restoration cannulation unit includes a head portion fixed into the shaft seat unit.

4. The injection die with an early-returning apparatus as claimed in claim 2, wherein the restoration pushing shaft unit includes a seat engaged with the upper fixed plate and a restoration pushing shaft extending from the seat.
